(19) United States
(12) Patent Application Publication
(10) Pub. No.: US 2003/0059049 A1
(43) Pub. Date: Mar. 27, 2003

(54) Method and apparatus for secure mobile transaction

(76) Inventors: Thomas J. Mihm JR., Crystal Lake, IL (US); Fred F. Bina, Coconut Creek, FL (US); Khanh Q. Nguyen, Hen Seng Garden (SG); Philip Moseley, Adelaide (AU)

Correspondence Address: MOTOROLA INC, 600 NORTH US HIGHWAY 45, LIBERTYVILLE, IL, 60048-5343, US

(21) Appl. No.: 09/961,718

(22) Filed: Sep. 24, 2001

(51) Int. Cl. H04L 9/00

(52) U.S. Cl. 380/270; 713/170

(57) ABSTRACT

A system for securing and authenticating wireless transactions. The method includes hard cooing a public key into a non-reprogramable ROM 114 through a first path 130 of a wireless communication device 116. An object to be stored on the wireless device is first signed by a private or secret key 104, which corresponds to the public key 104, to create a certificate 120. The certificate 120 is then bound to the object and both are subsequently sent to the wireless device 116 though a second path 132, which is different from the first path 130. A certified program segment 119 is also stored on the wireless device and is executed upon the boot up process of the device. During the boot process of the device, the certified program segment 119 is authenticated, and if authentic, it is executed. During the execution of the authenticated certified program sequence 119, certificates of corresponding objects stored on the device are authenticated by the public key and cryptographic program segments stored in the non-reprogramable ROM.

### BACKGROUND OF THE INVENTION

The present invention relates generally to mobile wireless communications, and more particularly to conducting secure transactions in wireless communication devices.

“Objects” are commonly passed from one computer to another. An object maybe but is not limited to software applications, security codes, and data sets etc. The object may be passed via, a RF link, an optical link, a wired network connection, through the internet, a serial or parallel port or internal bus transfers. When the object is passed from one device or portion to another, the integrity of the object can vary. The integrity is based upon how well the source is trusted, i.e. the integrity of the object's source and all processes that operate upon it within the system, including how the object is communicated to the destination. If the source of the object is known and is trusted, the integrity of the object is very high but as it is transferred through the system its integrity may be reduced.

The problem of maintaining an object's integrity is more difficult when the destination is a mobile device because it is not possible to predict the path the object will take as it moves through the system. More specifically, with the advent of wireless communications including the wireless internet and electronic commerce (eCommerce) and mobile eCommerce (mCommerce), in a system that does not have protection mechanisms, the integrity of the object, as it is passed over the air, through RF or light transmission, is reduced even further than with traditional wired connections. This is because the transmissions are susceptible to propagation effects and can be more readily intercepted out of the air than over a wired connection and potentially manipulated by adverse users.

Methods traditionally used in wired networks for securing transactions, or the passing of objects from one computer to another are data encryption such as secret key encryption, public key encryption, and authentication through certificates and signatures. For example, a trusted high integrity source is required to sign an object with the Secret Key of a Public Key/Secret Key pair before releasing it to all of the devices in the system. In addition, the Public Key called the “root” Public Key is also distributed to all the devices in the system. Possessing the root Public Key gives each device the ability to check the integrity of any object it receives by processing the signature with the root Public Key. A valid signature identifies the source of the object as the owner of the Secret Key (a trusted source with high integrity) and indicates that none of the system processes have altered the object's integrity. This method has been shown to be effective in presently deployed systems but is dependent on the assumption that a high integrity process was used to initially install the root Public Key in the device.

Incorporating additional functionality into wireless devices has created a need for additional security than that used traditionally in wireless devices. Current generations of mobile devices have used root Pubic Keys as a means for securing transactions or the passing of objects in the system. Even though the cryptographic process provides a high level of assurances about the signature of an object, there is no assurance that the object's integrity is any greater than the integrity of the process the initially installed the root Public Key. If, for example, the root Public Key was downloaded from an internet website, it has no more assurance of integrity than the website it was obtained from. Furthermore, any object's signature processed by the same root Public Key has no more assurance of integrity than that of the same website. This is unacceptable. Higher levels of security are becoming necessary as businesses provide services through mCommerce to exploit the new wireless generation. Current security methods used in wired networks such as the Internet do not provide adequate protection. That would leave the mCommerce vulnerable to attacks.

WAP and other browser enabled protocols provide the means to perform secure mobile ecommerce transactions (such as mobile banking) but rely on unspecified secure processes to install the root public keys used during a secure transaction. Mobile banking applications give the user the ability to do their banking anywhere within a wireless domain. It is highly desirable to incorporate these features into wireless devices. It also requires the device to carry out high assurance processes such as validating the identity and source of the incoming information and reliably identifying the device to the system. The integrity of these processes is directly related to the integrity of the process that was used to install the root Public Key upon which they depend. Current systems cannot provide this level of assurance.

Currently, high assurance methods for installing root Public Keys have been infeasible with respect to the development and manufacture of mobile devices. They have lacked the flexibility needed for the fast paced development cycle and high volume manufacturing. Flexibility in developing, programming and manufacturing mobile devices is a necessary feature of any feasible security process. At the same time, the integrity of the process cannot be lowered for the sake of flexibility. Current systems and methods do not meet both the device development flexibility requirements and the high integrity security requirements.

Accordingly, a system is needed to improve the assurance of secure wireless transactions yet maintain flexible product development and manufacturing. Providing a means for secure transactions over mobile devices is necessary to allow such transactions as electronic banking, electronic commerce but at the same time providing flexible means for developing, upgrading and maintaining the electronic wireless devices is necessary

### BRIEF DESCRIPTION OF THE DRAWINGS

FIG. 1 is an exemplary process diagram of the present invention.

FIG. 2 is a block diagram of an exemplary MPU of the present invention.

FIG. 3 is a representation of an exemplary architecture of the present invention.

FIG. 4 is an exemplary initialization process diagram of the present invention. FIG. 5 is an exemplary control loop diagram of the present invention.

### DETAILED DESCRIPTION OF INVENTION

An improved system and method is described for establishing a high integrity secure transaction over a wireless connection. The system includes a public key embedded within the tamper resistant media of non-reprogrammable Read Only Memory (ROM) by a first trusted path within an electronic device. The system then requires objects which are passed through a discrete second path to the electronic device to be authenticated by the super root public key during the boot process of the electronic device. Because the object is authenticated by a trusted source, the object will be considered trusted and allowed to reside on the device. Those skilled in the art will recognize the use of public key infrastructure (PKI) and authentication processes that the present invention makes use of. The PKI can be any of a number of systems in use today. This invention does not provide a PKI but rather provides the means for high assurance that the security and integrity of the PKI processes in the mobile wireless device are at the highest level offered by the PKI.

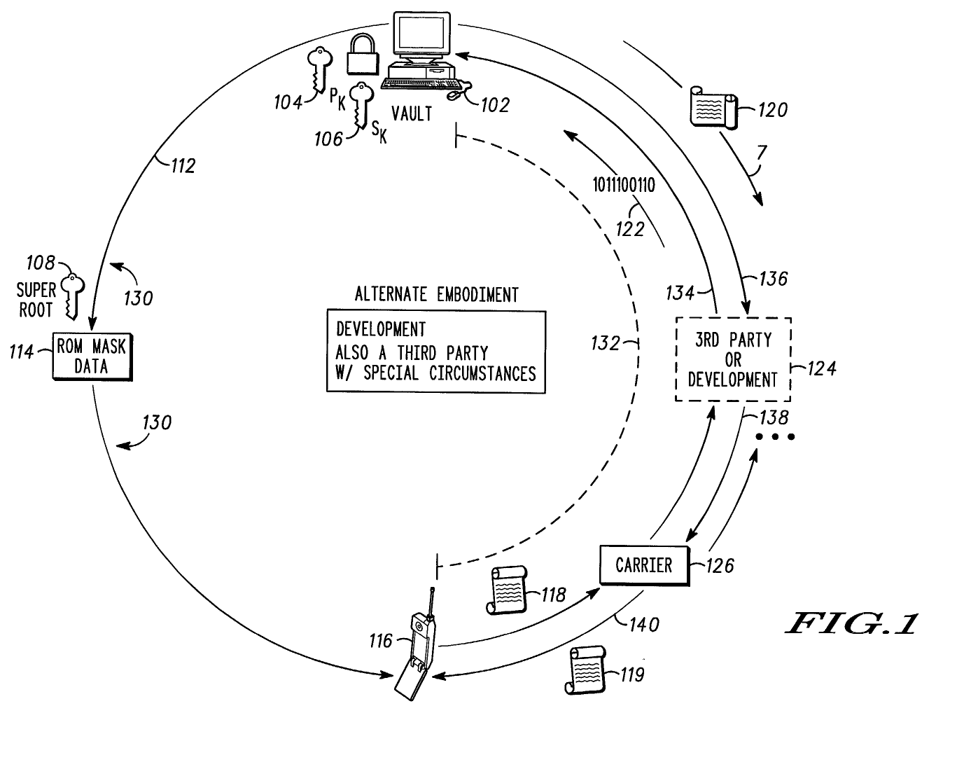

In FIG. 1, a central authority or certificate authority (CA) 102 is shown and the CA generates a public key 104 and a secret key 106, as a public key secret key pair. The public key 104 compliments the secret key 106 in a manner such that data encrypted by the public key 104 can only be decrypted with the secret key 106 and vice versa. Both the public key 104 and the secret key 106 can be used for both encrypting and decrypting as well as signing authentication certificates. In one embodiment, the CA 102, also functions as the key management authority storing and protecting the secret key 106 and the public key 104.

In one embodiment of the present invention, the public key 104 is signed with the secret key 106 to form the super root public key 108. The public key 108 does not need to be signed by the secret key, however when it is, this ensures that the public key is not tampered with during the IC fabrication process.

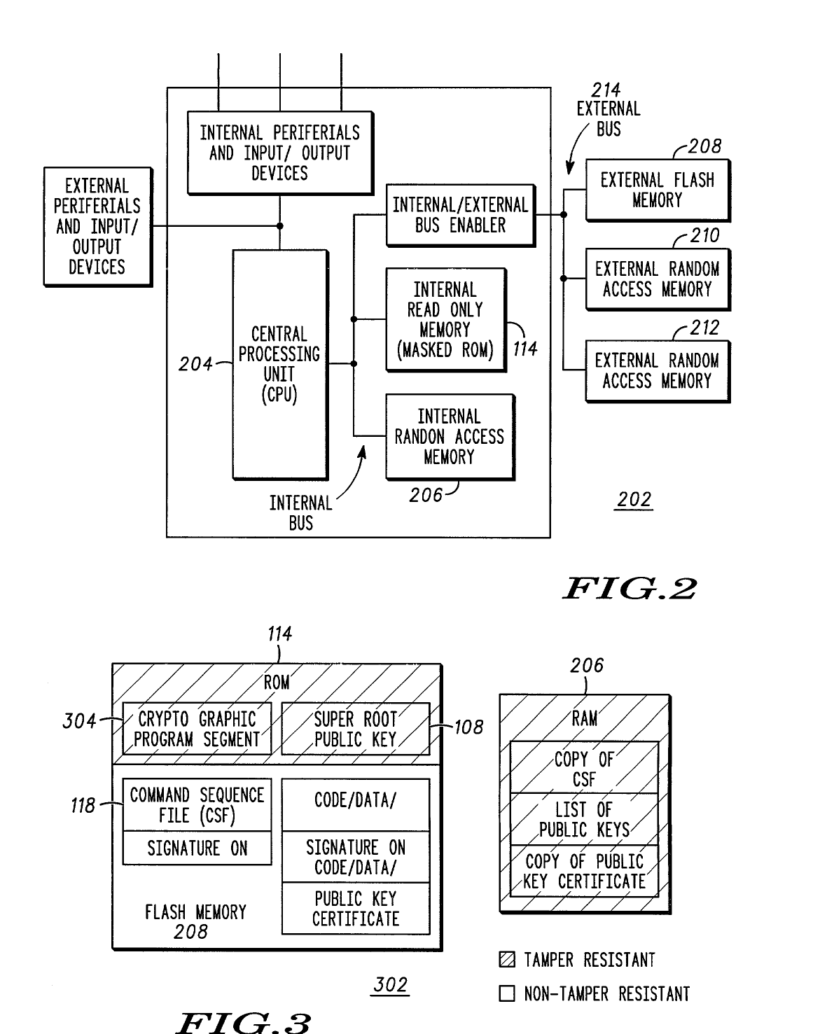

The super root public key 108 is sent to the Integrated Circuit (IC) fabrication facility as part of the Read Only Memory (ROM) mask data 113 via a high integrity first path 128. The ROM mask data 113 is a small part of the total database used in the fabrication of a specific IC. A typical configuration of the IC and other supporting components that might be found in a wireless communication device 116 is shown in FIG. 2. Here, a block diagram of a processing unit 202 is part of a cellular radiotelephone. In one embodiment, the IC that contains the ROM mask data 113 is the main processing unit (MPU) 202, available from Motorola Inc, is for carrying out network transactions when installed in the wireless communication devices 116.

The MPU 202 of FIG. 2 has a central processing unit 204, an internal non-reprogramable read only memory (ROM) 114 and an internal random access memory (RAM) 206. External flash memory 208, external RAM 210 and external ROM 212 are also coupled to the MPU 202 through a bus 214. As a result of the masking process the public key 104 or super root public key 108 is hard coded into the non-reprogramable ROM 114. As a result of this process, the path normally used to route IC fabrication data to the IC fabrication facility has the same high integrity as the first path 128 from the CA 102 to the non-reprogramable ROM 114 in the mobile device's 116 MPU 202. This IC fabrication path also has a high assurance of integrity because of the proprietary nature and potential value of the IC fabrication data.

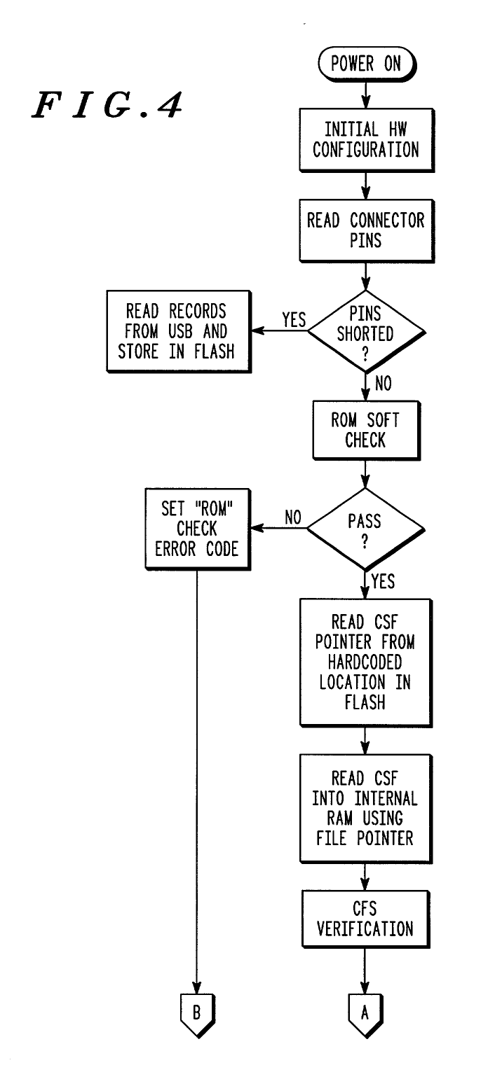

In addition to the super root Public Key 108 the ROM mask data also contains the High Assurance Boot Process (HABP) code that is always the first code to be executed when power is applied to the MPU 202, i.e. during the boot-up process. The memory allocation between the non-reprogramable ROM 114, RAM 206 and external flash memory 208 in FIG. 3 shows that the plurality of code segments comprise, cryptographic algorithms or cryptographic program segments 304 implemented by a command file parser and interpreter and small routines, initialization and configuration routines, several self test routines, main logic control loop, several command file validation routines. The cryptographic program segments is a routine or program that calls upon the public key 108 also stored in the ROM for authenticating, encrypting or decrypting other objects or program segments present on the device.

In FIG. 1, the non-reprogramable ROM, which comprises the super root public key 108 and the cryptographic program segment 304, installed into a device 116, such as a wireless communication device 116 of the preferred embodiment of the present invention, during the device assembly process. A program sequence called the Command Sequence File (CSF) 118 is also stored in the device during the assembly process. This program sequence is not stored in the ROM but in some form of re-writable memory in the device, for example the flash memory 208. The CSF 118 can therefore be replaced or modified at a later time as objects are added to or deleted from the device. The CSF 118 is executed as part of the boot process, in addition to execution of device initialization steps of the wireless communication device. Prior to installation into the wireless communication device 116, the CSF 118 is signed by the super root public key 108 such that it becomes a certified program sequence 119. Then, during the boot up process the certified program sequence 119 is authenticated by the super root public key 108 and cryptographic program sequence 304 which again are both stored in the ROM. If the certified program sequence 119 is authentic, the wireless communication device enters a normal operation mode and the certified program segment executes. If the certified program sequence fails authentication or is not authentic, the wireless communication device enters an alternate mode of operation.

This alternate mode can be a plethora of modes depending on the given circumstances, for example the device may display a message that an error has occurred and that the manufacture should be contacted or the device may also display troubleshooting tips. The alternate mode may also be to notify the service provider that the device has an invalid CSF and that the device may have been tampered with. The device may also enter an emergency only mode where the user can now only make calls to 911 and must take the device into the service provider to have the issue resolved.

Execution of the authenticated certified program segment 119, comprises executing other sub routines or program segments that authenticate other program segments stored in the wireless communication device. Because the certified program segment 119 is authenticated by the super root public key, there is high assurance that other program segments executed by the certified program segment 119 are authentic as well as the trust chain flows from the super root public key.

For example, code in the MPU 202 ROM 114, including the cryptographic program segment 304, and the CSF 119 directs the use of the super root public key 108 to authenticate other objects in the device 116. Other objects may include but are not limited to software segments, executable software segments, public keys, secret keys, data files, and cryptographic program segments.

In general a third party who desires to have its object reside on the device will need to have the object signed for authentication purposes prior to delivery to the device 116. To this end, once the public key secret key pair have been generated by the CA 102, and the super root public key 108 embedded in the non-reprogramable ROM 114 and incorporated into a wireless device 116, objects to be delivered to the wireless device must be signed by the CA 102 to ensure their authenticity once installed on the device 116. Signing the object by the private key 106 at the CA 102 generates a certificate 120, as shown in FIG. 1. The certificate is attached to the object when it is sent to the wireless communication device 116. At the device 116, the object and certificate 120 are authenticated with the super root public key 108. If the certificate is authentic, then the object can be used on the device 116.

An example of a third party in this instance, may be an institution wishing to provide an object via the internet to the wireless device. Many third party providers will wish to download data in mCommerce transactions. Another third party may be the service provider or carrier providing service to the device who also wishes to upgrade software in the device or add any other object to enhance features of the device, otherwise known as terminal management. The nature of these transactions require that the object be authenticatable and traceable back to the trusted source.

An element of the system is that the object is communicated to the device via a completely separate path from that of the super root public key 108. The first path and the second path may be the same media (i.e. floppy disk, wired transmission, wireless transmission, however they cannot be apart of the same transaction so as to create the independent paths. The second path can be any typical communication path through the network to the mobile device. The path does not need to be of high integrity because any change in the objects integrity as it moves through the network to the device will be detected when the object is processed by the super root public key

In FIG. 1, the object is shown taking the second path 132. For illustrative purposes, the second path further comprises a first portion 134, a second portion 136 and a third portion 138. Before the object can be sent to the wireless device 116, the third party must send the object through the first portion 134 of the second path 132, to the CA 102. At the CA 102, the object is signed with the secret key 106. In doing this, the Third Party is said to “registering” with the CA and this process is know as “Registration”. The first portion of the second path can be a person to person transaction, a dedicated wired link, transported by recordable media such as floppy disk, CD ROM, or some form of removable portable media. The object must also contain an identification code (ID field) that clearly identifies the source of the object and a checksum over all of the fields in the object. The ID field binds the third party's public key to the third party's identifier. The certificate “guarantees” the identity of the third party and “certifies” authenticity of their public key.

The signed object is returned from the CA 102 to the third party 124 via a second portion of the second path. This can be the same type of communication as the first portion or another means as described above may be used. Once the signed object is received at the third party 124, it can be communicated to the wireless device. In the preferred embodiment of the present invention, the object is communicated to the wireless device from the third party via a carrier though a third portion of the second path. If the third party is the carrier the object is sent directly to the wireless communication device 116. Once the object is received at the wireless device 116, both the object and the super root public key 108 reside on the wireless communication device via two completely autonomous paths; the first high integrity path 128 and the second, a typical network path 132. This system is designed to accommodate the flexibility of origination of the objects when sent to the wireless communication device, i.e. the second path in this case, and this path by nature is not a high integrity path and therefore requires the certification prior to transmission to the wireless communication device.

During the boot process of the device, the CSF 118 is executed and authenticates every signed object stored in the device received in the second path, using the super root Public Key. If every object is authentic, then the device will complete the boot process and enter an operation mode. If any object is not authentic, the device will not begin normal operations and will go into an alternate operation mode. This alternate mode may be shutting down the device, displaying a message to call the service provider or the 3^{rd} party or a number of other possible events.

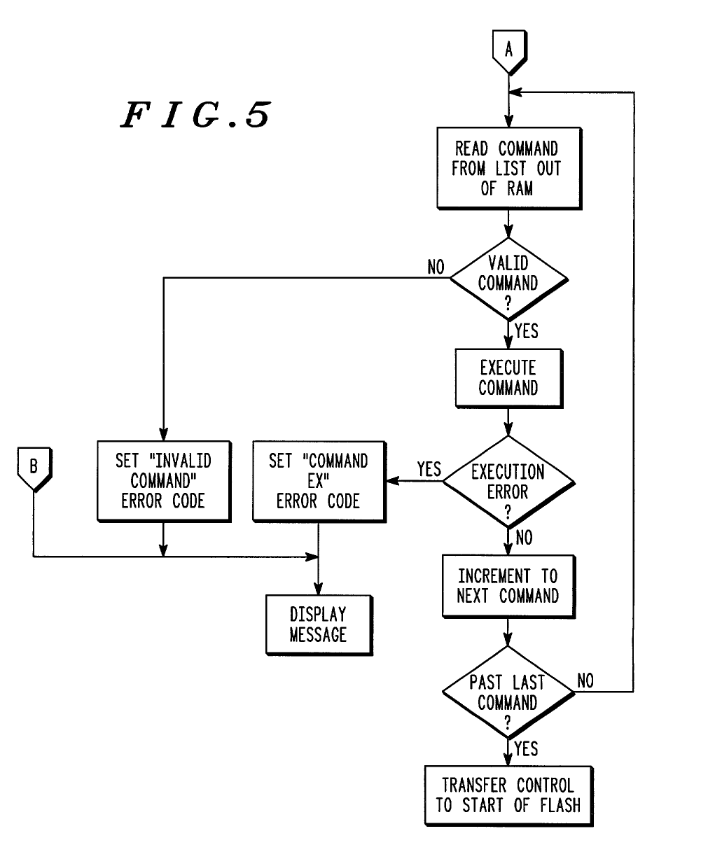

Once the wireless communication device receives an object, the object can not be activated until the object is authenticated. The authentication process begins when power is applied to the IC and the initialization code in the ROM is activated and establishes full control of the MPU as shown in FIG. 4. The ROM code always executes the same specific sequence of actions upon every boot up.

FIG. 5 shows the main control loop sequence. First the main control loop looks for the CSF pointer and uses it to locate the command CSF 119 itself. It loads the CSF 119, along with the CSF Signature, into the RAM 206 internal to the MPU 202. The main control loop code then calls several of the cryptographic library routines contained in the ROM to establish the authenticity and integrity of the CSF 119. In the preferred embodiment of the present invention, the CSF Signature is a checksum of the CSF 119 called a HASH that is signed with the super root Secret Key 108. The CSF 119 then performs the decryption of the first object using the super root public key 108. The result of processing the first object with the super root public key 108 is a decrypted answer or result. The result is verified by checking the checksum that is included in the encrypted object. If the object is authentic the CSF 119 moves on to the next object and follows the same procedure of authenticating the second object with the super root public key 108. This process is carried out until all objects are verified. If the object/Public key is not authentic, the device can enter an alternative mode, signal the user, or disable the device. The alternative mode may be that the object is re-downloaded to the device, or the device enters an emergency use only mode such that the user can only call 911 for example. The device may also enter a terminal management mode allowing the carrier to control the device and troubleshoot the issue. The user may be signaled to call a number, or the number called automatically in the case of a cellular radiotelephone, such as the carrier or the third party who has generated the object in question for further troubleshooting.

Each time a new object is downloaded to the device, a new CFS 119 must be stored in the device 116 as well. The CFS 119 must include the object that is to be verified upon booting of the device. The CFS 119 may also include an ID number that matches the ID number in the device such as an electronic serial number (ESN) of a cellular radio telephone, such that if the CFS 119 is stored on a device with a different ESN, the device can enter an alternate mode of operation. In this case the device could send a notification to the carrier that the CFS 119 ID does not match the device ID and the device could be interrogated for fraud or other misuse such as cloning.

In the development phase of the wireless device, the development group may act as the third party. Development requires full access to the device. Objects store on the device would then be such things as development data, executables or another key that grants complete access to the wireless device for development purposes. Development is given a CFS 119 to download to the device that give s full access. Special development ROMs may also be installed in the development device during the development process. In the special development ROM would have a unique ID that matches the ID in the development CFS 119. Because only a certain number of ROMs with t unique development ID would be developed, devices with the special development ROM would not be sold in commerce. This advantageously allows flexibility in the development process while marinating a system that has a high security level.

The third party may also be a field testing unit who needs to upgrade software in the device during testing. The field testing unit would be given a CFS 119 to be downloaded into the device that gives either full access to the device or a field testing access level of security.

Objects sent to the device by carrier, by request by the user, banking request, shopping requests, any mCommerce in general, gaming, video streaming???

While the invention has been described in detail above, the invention is not intended to be limited to the specific embodiments as described. It is evident that those skilled in the art may now make numerous uses, modifications of, and departures from the specific embodiments described herein without departing from the inventive concepts.

What is claimed is:

1. A method in a wireless communication device comprising:
applying power to the wireless communication device; and
authenticating a certified program segment with a cryptographic program segment and a public key in response to applying power to said wireless communication device,
said cryptographic program segment and said public key are hard coded into a non-reprogramable read only memory (ROM) of said wireless communication device.

2. The method of claim 1 executing said certified program segment if said certified program segment is authenticated, said certified program segment having an object authentication program segment.

3. The method of claim 1 entering said wireless communication device into an alternate mode of operation if said certified program segment is not authentic.

4. The method of claim 2 authenticating an object in said wireless communication device with said public key and said cryptographic program segment in response to execution of said object authentication program segment of said certified program segment.

5. The method of claim 4 further comprising entering said wireless communication device into a second alternate mode of operation if said object is not authentic.

6. The method of claim 2 authenticating an object in response to executing said object authentication program segment in said certified program segment, wherein said at least one object authentication program segment comprises a first pointer, pointing to said public key of said non reprogramable ROM and a second pointer pointing to said cryptographic program segment of said non reprogramable ROM.

7. The method of claim 1 installing said cryptographic program segment and said public key on said wireless communication device through a first path.

8. The method of claim 7 authenticating an object in said wireless communication device with said public key and said cryptographic program segment in response to said certified program segment, said object and said certified program segment installed in said wireless communication device through a second path, said second path being different from said first path.

9. The method of claim 4 receiving said object through a wireless interface of said wireless communication device before authenticating said object.

10. The method of claim 4 further comprising downloading a new object and a corresponding certified program segment onto said wireless communication device,
said corresponding certified program segment having a second object authentication program segment to authenticate said new object.

11. An wireless communication device comprising:
a microprocessor;
a non-reprogramable ROM coupled to said microprocessor;
a cryptographic program segment hard coded into said non reprogramable ROM;
a certified program segment; and
a public key hard coded into said non-reprogramable ROM for authenticating said certified program segment.

12. The wireless communication device of claim 11 comprising a memory unit coupled to said microprocessor.

13. The wireless communication device of claim 12 comprising an object, wherein said object is stored in said memory unit, and an authentic certified program segment for authenticating said object.

14. The wireless communication device of claim 11 wherein said certified program segment is authenticated by said cryptographic program segment and said public key during the boot up process of the wireless communication device.

15. The wireless communication device of claim 12 wherein said certified program segment is stored in said memory unit.

16. The wireless communication device of claim 11 wherein said wireless communication device is a cellular radiotelephone handset.

17. The wireless communication device of claim 11 wherein said non-reprogramable ROM is internal to said microprocessor.

18. The wireless communication device of claim 11 wherein said non-reprogramable ROM is a mask programmed ROM.

19. The wireless communication device of claim 11 wherein the publick key is signed with a private key to form said super root public key.

20. An wireless communication device comprising:
a central processor means;
a non-reprogramable ROM coupled to said central processor means for storing a plurality of hard coded program segments;
a transceiver coupled to said central processor means;
a certified program segment stored on said wireless communication device;
a public key hard coded into said non-reprogramable ROM; and
an authenticating means hard coded into said non reprogramable ROM for authenticating said certified program segment with said public key during a boot process of the wireless communication device.

21. The wireless communication device of claim 20 comprising an object stored on said wireless communication device, said object authenticated by said authenticating means in response to execution of said certified program segment in response to said certified program segment being authenticated.

22. The wireless communication device of claim 20 comprising a new object installed in said wireless communication device through a wireless interface.

23. The wireless communication device of claim 21 comprising a new certified program segment stored in said wireless communication device for authenticating said new object.
